(19) United States
(12) Patent Application Publication
(10) Pub. No.: US 2025/0245450 A1
(43) Pub. Date: Jul. 31, 2025

(54) SERVICE EXECUTION METHODS AND APPARATUSES, STORAGE MEDIA, AND ELECTRIC DEVICES

(71) Applicant: Alipay (Hangzhou) Information Technology Co., Ltd., Hangzhou (CN)

(72) Inventors: Pengqing Bao, Hangzhou (CN); Jiani Li, Hangzhou (CN); Deng Pan, Hangzhou (CN); Tianyi Zhang, Hangzhou (CN)

(73) Assignee: Alipay (Hangzhou) Information Technology Co., Ltd., Hangzhou (CN)

(21) Appl. No.: 19/042,311

(22) Filed: Jan. 31, 2025

(30) Foreign Application Priority Data
Jan. 31, 2024 (CN) 202410141512.3

(51) Int. Cl. G06F 40/40; G06F 40/253; G06F 40/279

(52) U.S. Cl. CPC G06F 40/40; G06F 40/253; G06F 40/279

(57) ABSTRACT

Described is a computer-implemented method, non-transitory, computer-readable medium, and computer-implemented system for service execution. A question statement of a user determined based on a service result output by a service model is acquired. A query statement used to query, based on, which the service model outputs the service result, user data of the user is generated based on the question statement. A query result is determined. The question statement is input into a recognition model that is pre-trained, to determine an interpretation strategy used for the question statement. Based on the query result through the interpretation strategy, an association relationship is determined between at least part of the user data and the service result. A reply statement is generated for the question statement based on the association relationship, to execute a target service through the reply statement.

### CROSS-REFERENCE TO RELATED APPLICATIONS

This application claims priority to Chinese Patent Application No. 202410141512.3, filed on Jan. 31, 2024, which is hereby incorporated by reference in its entirety.

### TECHNICAL FIELD

This specification relates to the field of computer technologies and the field of artificial intelligence, and in particular, to service execution methods and apparatuses, storage media, and electronic devices.

### BACKGROUND

With continuous development of artificial intelligence technologies, artificial intelligence models are currently already used in many fields. For example, in intelligent driving, collected driving data can be used to plan a path, to control vehicle driving. For another example, personal information authorized by a user is input into the artificial intelligence model, to perform service risk control on the user.

However, for many current service scenarios, when the user makes decisions based on an output result of the artificial intelligence model, a basis for the corresponding output result usually needs to be provided in combination with the artificial intelligence model so that the user can formulate a solution in a more reasonable way. However, how to accurately interpret the output result of the artificial intelligence model is a technical problem that needs to be alleviated.

### SUMMARY

One or more embodiments of this specification provide service execution methods and apparatuses, storage media, and electronic devices, to partially alleviate the above-mentioned problem that exists in a conventional technology.

The following technical solutions are used in embodiments of this specification.

This specification provides a service execution method, including: acquiring a question statement of a user, where the question statement is determined based on a service result output by a service model; generating a query statement based on the question statement, where the query statement is used to query user data of the user based on which the service model outputs the service result; determining a query result based on the query statement; inputting the question statement into a recognition model that is pre-trained, to determine an interpretation strategy used for the question statement; determining, based on the query result through the interpretation strategy, an association relationship between at least part of the user data and the service result output by the service model; and generating a reply statement for the question statement based on the association relationship, to execute a target service through the reply statement.

Optionally, the generating a query statement based on the question statement specifically includes: dividing the question statement, to obtain component words based on the division; performing part of speech tagging on the component words, to obtain a tagging result; determining, as a target component word based on the tagging result, a component word whose part of speech is a noun from the component words, and determining a corresponding query parameter in the query statement based on the target component word; and determining the query statement based on the query parameter.

Optionally, pre-training the recognition model specifically includes: acquiring each training sample, where the training sample is a simulation of the question statement determined by the user based on the service result output by the service model; inputting the training sample into a to-be-trained recognition model, so that the to-be-trained recognition model extracts a feature of the training sample, and determines, based on extracted feature information, an interpretation strategy corresponding to the training sample; and training the to-be-trained recognition model with an optimization target of minimizing a deviation between the interpretation strategy corresponding to the training sample and a tagged interpretation strategy corresponding to the training sample.

Optionally, the determining, based on the query result through the interpretation strategy, an association relationship between at least part of the user data and the service result output by the service model specifically includes: determining the at least part of the user data based on the query result and the interpretation strategy; adjusting, based on each piece of user data included in the at least part of the user data, a corresponding user data value included in the query result, to obtain adjusted user data; inputting the adjusted user data into the service model, to obtain an adjusted service result; determining, based on the adjusted service result and the service result output by the service model based on the query result, a deviation corresponding to the user data; determining, based on the deviation, an association relationship between the user data and the service result output by the service model, where the association relationship indicates importance of the user data to the service result output by the service model; and determining, based on the association relationship, the association relationship between the at least part of the user data and the service result output by the service model.

This specification provides a service execution apparatus, including: an acquisition module, configured to acquire a question statement of a user, wherein the question statement is determined based on a service result output by a service model; a generation module, configured to generate a query statement based on the question statement, where the query statement is used to query user data of the user based on which the service model outputs the service result; a first determining module, configured to determine a query result based on the query statement; a second determining module, configured to input the question statement into a recognition model that is pre-trained, to determine an interpretation strategy used for the question statement; a third determining module, configured to determine, based on the query result through the interpretation strategy, an association relationship between at least part of the user data and the service result output by the service model; a reply module, configured to generate a reply statement for the question statement based on the association relationship, to execute a target service through the reply statement; and a reply module, configured to generate a reply statement for the question statement based on the association relationship, to execute a target service through the reply statement.

Optionally, the generation module is specifically configured to divide the question statement, to obtain component words based on the division; perform part of speech tagging on the component words, to obtain a tagging result; determine, as a target component word based on the tagging result, a component word whose part of speech is a noun from the component words, and determine a corresponding query parameter in the query statement based on the target component word; and determine the query statement based on the query parameter.

Optionally, the second determining module is specifically configured to acquire each training sample, where the training sample is a simulation of the question statement determined by the user based on the service result output by the service model; input the training sample into a to-be-trained recognition model, so that the to-be-trained recognition model extracts a feature of the training sample, and determines, based on extracted feature information, an interpretation strategy corresponding to the training sample; and train the to-be-trained recognition model with an optimization target of minimizing a deviation between the interpretation strategy corresponding to the training sample and a tagged interpretation strategy corresponding to the training sample.

Optionally, the third determining module is specifically configured to determine the at least part of the user data from the query result based on the interpretation strategy; adjust a user data value of the at least part of the user data, to obtain adjusted user data; input the adjusted user data into the service model, to obtain an adjusted service result; determine a deviation between the adjusted service result and the service result output by the service model based on the query result; and determine, based on the deviation, the association relationship between the at least part of the user data and the service result output by he service model.

This specification provides a computer-readable storage medium. The storage medium stores a computer program. When the computer program is executed by a processor, the above-mentioned service execution method is implemented.

This specification provides an electronic device, including a storage, a processor, and a computer program that is stored in the storage and that can run on the processor. When the processor executes the program, the above-mentioned service execution method is implemented.

The above-mentioned at least one technical solution used in embodiments of this specification can achieve the following beneficial effects:

In one or more embodiments of this specification, a question statement entered by a user for a service result output by a service model is first acquired, then a query statement is generated based on the question statement, where the query statement is used to query user data of the user that are used when the service model outputs the service result, a query result is obtained based on the query statement, further, the question statement is input into a recognition model that is pre-trained, to determine an interpretation strategy used for the question statement, and an association relationship between at least part of the user data and the service result output by the service model is obtained based on the query result through the interpretation strategy, to further generate a reply statement for the question statement based on the obtained association relationship, to execute a target service through the reply statement.

In this method, an interpretation strategy corresponding to a question statement entered by the user is determined by using the recognition model that is pre-trained, to determine the interpretation strategy applicable to the question statement, so that the association relationship between the at least part of the user data and the service result output by the service model is obtained by using the corresponding interpretation strategy, and further the reply statement for the question statement is generated based on the association relationship, thereby further improving accuracy of the reply statement.

### BRIEF DESCRIPTION OF DRAWINGS

The accompanying drawings described here are used to provide a further understanding of this specification and constitute part of this specification. The example embodiments of this specification and descriptions thereof are used to explain this specification, and do not constitute an improper limitation on this specification. In the accompanying drawings:

FIG. 1 is a schematic flowchart illustrating a service execution method, according to one or more embodiments of this specification;

FIG. 2 is a diagram of a structure illustrating a service execution apparatus, according to one or more embodiments of this specification; and

FIG. 3 is a diagram of a structure illustrating an electronic device, according to one or more embodiments of this specification.

### DESCRIPTION OF EMBODIMENTS

To make the objectives, technical solutions, and advantages of this specification clearer, the following clearly and comprehensively describes the technical solutions of this specification with reference to specific embodiments and the accompanying drawings of this specification. Clearly, the described embodiments are merely some but not all of embodiments of this specification. All other embodiments obtained by a person of ordinary skill in the art based on embodiment of this specification without creative efforts shall fall within the protection scope of this specification.

The following describes in detail the technical solutions provided in embodiments of this specification with reference to the accompanying drawings.

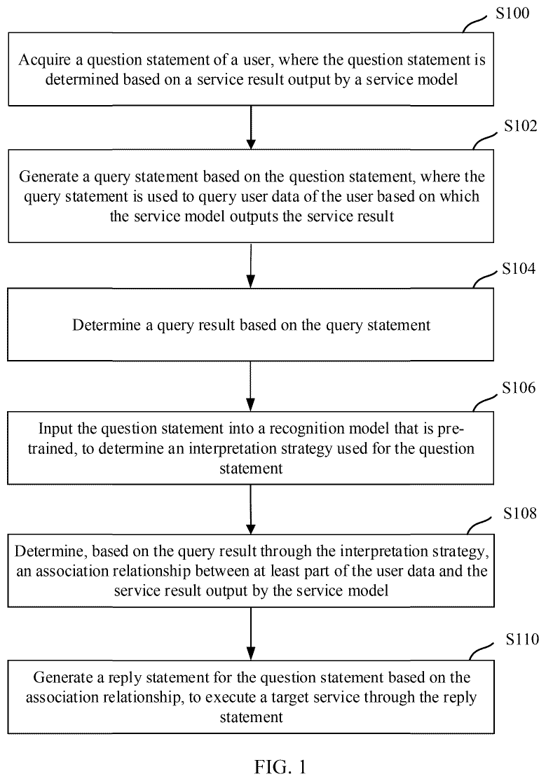

FIG. 1 is a schematic flowchart illustrating a model deployment method, according to one or more embodiments of this specification.

S100: Acquire a question statement of a user, where the question statement is determined based on a service result output by a service model.

With development of artificial intelligence technologies, artificial intelligence models with more functions are used in various fields such as healthcare, finance, and transportation. A result corresponding to a user is provided, by using the artificial intelligence model, based on user data authorized by the user.

However, because the artificial intelligence model usually includes a complex neural network, a decision-making process thereof cannot be intuitively understood. In addition, the artificial intelligence model may make wrong predictions due to insufficient training data during a training process, and credibility of an output result of the artificial intelligence model cannot be guaranteed usually. Therefore, the output result of the artificial intelligence model needs to be interpreted.

For example, in the healthcare field, the artificial intelligence model is used to predict a disease of a patient based on case information authorized by the patient, and an output result of the artificial intelligence model is interpreted to make clearer a basis of decision-making of the artificial intelligence model, to help a doctor better understand a condition of the patient and formulate a more precise treatment plan.

For another example, in the finance field, the artificial intelligence model is used to perform risk assessment and credit evaluation based on user data authorized by a borrower, and if an output result is that a high risk or a bad credit risk of the borrower exists, a basis of the output result provided by the artificial intelligence model needs to be clarified, so that a financial institution can better assess a credit risk of the borrower, thereby formulating a more reasonable credit strategy.

At present, some specific interpretation ways can alternatively be used to provide a corresponding basis for the output result of the artificial intelligence model. However, because these interpretation ways can only be applied to specific types of artificial intelligence models or specific types of datasets but are not applicable to all types of data, generalization is poor. In addition, human intervention is needed to select a corresponding interpretation way, leading to a certain degree of subjectivity and poor accuracy of an interpretation result obtained by the user.

To alleviate the above-mentioned problems, in one or more embodiments of this specification, a question statement entered by the user for the service result output by the service model is first acquired, and then a query statement is generated based on the question statement. The query statement is used to query user data of the user that are used when the service model outputs the service result, a query result is obtained based on the query statement, further, the question statement is input into a recognition model that is pre-trained, to determine an interpretation strategy used for the question statement, and an association relationship between at least part of the user data and the service result output by the service model is obtained based on the query result through the interpretation strategy, to further generate a reply statement for the question statement based on the obtained association relationship, to execute a target service through the reply statement.

In this method, an interpretation strategy corresponding to a question statement entered by the user is determined by using the recognition model that is pre-trained, to determine the interpretation strategy applicable to the question statement, so that the association relationship between the at least part of the user data and the service result output by the service model is obtained by using the corresponding interpretation strategy, and further the reply statement for the question statement is generated based on the association relationship, thereby further improving accuracy of the reply statement.

The service execution method provided in this specification can be performed by using a terminal device, such as a desktop computer or a laptop computer, as an execution body, or can be performed by using a server as an execution body. For ease of description, the following describes a service execution method provided in this specification by using only the terminal device as an execution body.

Next, in one or more embodiments of this specification, the terminal device first needs to obtain a question statement of a user, where the question statement referred to here is determined by the user based on a service result output by the service model.

For example, the service model used by the user is used to evaluate a credit score of the user. After the user enters personal data into the service model based on a prompt, a score of 50 points is obtained, which is lower than a standard scoring result. Therefore, the user enters a question statement, for example, a question such as “Why is my credit score 50 points? Please tell me a basis for the output of the score by the service model.” or “For the service model, what user data of a user are more important?”, in the terminal device based on the scoring result, and then the terminal device performs a further operation based on the question statement entered by the user, to provide an interpretation corresponding to the user.

It is worthwhile to note that the user can select any language, for example, English or Chinese, in a graphical user interface provided by the terminal device.

S102: Generate a query statement based on the question statement, where the query statement is used to query user data of the user based on which the service model outputs the service result.

In one or more embodiments of this specification, the terminal device preprocesses the question statement entered by the user, to produce a corresponding query statement based on a keyword included in the preprocessed question statement.

Specifically, in this specification, the terminal device divides the question statement, to obtain component words based on the division, then performs part of speech tagging on the obtained component words, to obtain a tagging result, determines, as a target component word based on the tagging result, a component word whose part of speech is a noun from the component words, and determines a corresponding query parameter in the query statement based on the obtained target component word, to determine the query statement based on the query parameter.

For example, the question statement entered by the user is “For the service model, what personal data of a user is more important to an output result?”. In this case, component words obtained after the division are “For/the service model/, /what/personal/data/of/a user/are/more/important/for/the output/result/?/” Further, the part of speech tagging is performed on each component word, for example, “For/p the service model/n,/w /what/r personal/a data/n of/p a user/n is/v more/d important/a for/p the output/vn result/n?/w”. Further, based on the tagging result, target component words are obtained as “service model”, “user”, “personal”, “data”, “output”, and “result”, and the corresponding target component words are used to obtain corresponding query parameters based on a syntactic rule of the query statement and are filled into a predetermined query statement template, to obtain the query statement.

The part of speech tagging here includes a preposition (p), a noun (n), a particle (u), a pronoun (r), a verb (v), an adverb (d), an adjective (a), and a punctuation (w).

In addition, the preprocessing can further include: text repair, to be specific, correcting a grammatical error, an irregular expression, or redundant information in the question statement; typo correction, to be specific, recognizing and correcting typos in the question statement; and speech recognition and synthesis, to be specific, converting a question statement input in a form of speech into text and converting the text into speech.

After words whose parts of speech are a noun included in the question statement are recognized in the above-mentioned way, the recognized words can be used to obtain corresponding query parameters based on a syntactic rule of the query statement by using a predetermined query statement template, and then, the query parameters can be filled into the predetermined query statement template to obtain the corresponding query statement.

The query statement referred to here can be, for example, a query statement in a form of SQL.

S104: Determine a query result based on the query statement.

In this specification, the terminal device sends, based on a query language, a request to a system deployed with a service model, to query the user data corresponding to the user from a predetermined database, and a service result output by the service model based on the user data.

For example, if the question statement entered by the user is “Why is my credit score 50 points?”, the terminal device sends, based on the query language, the request to the system deployed with the service model, and then obtains the user data, to be specific, a deposit, an annual income, and a history of bad credit records, and a service result 50 output by the service model based on the user data, etc., that corresponds to the user.

Then, the terminal device further analyzes, based on acquired data information, the question statement entered by the user.

It is worthwhile to note that a service result derived by the service model each time can be stored in the database, and can be stored, in a storage process, in binding with an identifier corresponding to the user, and then, the terminal device can obtain, by using the query statement, the service result output by the service model based on the user data entered by the user.

S106: Input the question statement into a recognition model that is pre-trained, to determine an interpretation strategy used for the question statement.

In this specification, the terminal device uses the recognition model that is pre-trained, to determine, based on the question statement entered by the user, an interpretation strategy to be used in response to the question statement entered by the user.

It is worthwhile to note that in this specification, when using the recognition model that is pre-trained, the terminal device first needs to pre-train to-be-trained a recognition model.

Specifically, the terminal device acquires each training sample, where each training sample is a simulation of a question statement determined by the user based on a service result output by the service model; inputs each training sample into the to-be-trained recognition model, so that the to-be-trained recognition model extracts a feature of each training sample, and determines, based on the extracted feature information, an interpretation strategy corresponding to each training sample; and train the to-be-trained recognition model with an optimization target of minimizing a deviation between the interpretation strategy corresponding to each training sample and a tagged interpretation strategy corresponding to each training sample, to obtain a trained recognition model as the recognition model that is pre-trained.

A cause why the recognition model that is pre-trained needs to be obtained is that the terminal device can determine, in response to a question statement entered by the user this time, an interpretation strategy suitable for the question statement, to improve accuracy of an interpretation result of the terminal device for the question statement and reduce subjectivity of manual intervention.

According to the above-mentioned method, after the recognition model that is pre-trained is obtained, the recognition model determines a corresponding interpretation strategy based on a keyword included in the question statement.

For example, if the question statement entered by the user is “For the service model, what are the three pieces of user data that have greater impact on a credit score?”, an interpretation strategy provided by the recognition model that is pre-trained is global sensitivity analysis based on keywords “service model, credit score, impact, greater, three, and user data” in the question statement; if the question statement entered by the user is “For a user, which user data of the user has greater impact on an output result of the service model”, an interpretation strategy provided by the recognition model that is pre-trained is local sensitivity analysis based on keywords “a user, which, user data, service model, output result, influence, and greater” in the question statement; if the question statement entered by the user is “Why is my credit score 40 points? Please provide a reasonable interpretation.”, an interpretation strategy provided by the recognition model that is pre-trained is feature importance analysis based on key words “my, credit score, 40 points, and interpretation” in the question statement; or if the question statement entered by the user is “How can I quickly reach the standard credit score?”, an interpretation strategy provided by the recognition model that is pre-trained is counterfactual analysis based on keywords “I, quickly, reach, standard, and credit score” in the question statement.

The global sensitivity analysis mentioned here refers to the following: For the service model, which types of user data of a majority of users have greater impact on an output result. The local sensitivity analysis refers to the following: For a user or a minority of users, which types of user data of this type of user have greater impact on an output result of the service model. The feature importance analysis refers to the following: For a user, which user data of the user has greater impact on an output result obtained by the user. The counterfactual analysis refers to the following: For a user, how the output result changes if a specific piece of user data does not exist or if the user data are improved, and a method that is easier for the user to achieve is selected.

The recognition model that is pre-trained is used, to determine, for the question statement entered by the user, the interpretation strategy used for the question statement, so that accuracy of an output result of the terminal device is improved, and reliability of an interpretation result is improved, thereby helping the user specify a more appropriate solution based on the obtained interpretation result.

S108: Determine, based on the query result through the interpretation strategy, an association relationship between at least part of the user data and the service result output by the service model.

In this specification, the terminal device determines, based on the acquired query result by using the interpretation strategy provided by the recognition model that is pre-trained, the association relationship between the at least part of the user data and the service result output by the service model.

Specifically, in this specification, the terminal device determines the at least part of the user data from the query result based on the interpretation strategy, adjusts a user data value of the at least part of the user data to obtain adjusted user data, and then, inputs the adjusted user data into the service model to obtain an adjusted service result, to determine a deviation between the adjusted service result and the service result output by the service model based on the query result, thereby further determining, based on the obtained deviation, the association relationship between the at least part of the user data and the service result output by the service model.

For example, if to-be-adjusted user data are an income of the user, the terminal device adjusts, based on the interpretation strategy, an original income of ten thousand yuan entered by the user into the service model to twenty thousand yuan, where remaining user data included in the query result remain unchanged, to obtain the adjusted user data, and then inputs the adjusted user data into the service model, to obtain a service result corresponding to the adjusted user data, thereby clearly knowing impact of a magnitude of an income change on the service result based on a size of a deviation between the service results output by the service model based on the two groups of user data before and after the adjustment.

In other words, the association relationship that is between the at least part of the user data and the service result output by the service model and that is obtained by the terminal device can be used to reflect whether the association relationship between the user data and the service result output by the service model is a strong association relationship or a weak association relationship.

To provide a clearer description of a process of determining the association relationship, an example is provided below for description.

If the question statement of the user is “Why is my credit score 50 points? Please provide a reasonable interpretation.”, the terminal device uses the recognition model that is pre-trained, to provide an interpretation strategy, namely, feature importance analysis, based on nouns, to be specific, “I, credit score, 50 points, and interpretation”, included in nouns obtained through division of the question statement. Common feature importance analysis includes: a model output-based method, a model parameter-based method, and feature-based correlation analysis.

Specifically, the terminal device interprets the query result by using the model output-based method, to be specific, views, if the service model is based on a decision tree, a structure of a model of a decision tree (where the decision tree comes with a feature importance score to evaluate importance of a feature) for user credit scoring, to find nodes related to the score of 50 points of the user based on a path of the decision tree, and obtains a corresponding interpretation based on feature information (user data) on which each node is based and a corresponding feature importance score; the terminal device interprets the query result by using the model parameter-based method, to be specific, changes a parameter of the service model, to learn of extent of a change between output results of the service model before and after the change, and determines, based on the extent of the change, the association relationship between the at least part of the user data and the service result output by using the service data; and the terminal device interprets the query result by using the feature-based correlation analysis method, to be specific, calculates a correlation between each piece of feature information (user data) and the credit score by using a metric method such as a correlation coefficient or mutual information, where the correlation here refers to importance of each piece of feature information to the output result of the service model, and determines the association relationship between the at least part of the user data and the service result output by using the service data.

After the association relationships between the at least part of the user data and the service results output by using the service data, in other words, corresponding interpretation results, are obtained in the above-mentioned ways, user data, in other words, feature information, corresponding to the query results, need to be changed for feature information included in the interpretation results, to obtain adjusted user data, then the adjusted user data are input into the service model, to obtain adjusted service results, to further filter the above-obtained association relationships based on deviation results obtained based on deviations between the adjusted service results and the service results output by the service model based on the query results, and an association relationship corresponding to a deviation result with a higher deviation is used as a target association relationship.

Further, the terminal device generates a corresponding reply statement based on the target association relationship.

S110: Generate a reply statement for the question statement based on the association relationship, to execute a target service through the reply statement.

After obtaining the association relationship between the at least part of the user data and the service result output by the service model in the above-mentioned way, the terminal device generates a reply statement for the question statement based on the obtained association relationship, to present an interpretation result for the question statement to the user based on the reply statement.

Specifically, in this specification, the terminal device converts the obtained association relationship, to be specific, a machine language, into a natural language, and presents the natural language as the reply statement to the user, where the reply statement mentioned here refers to the natural language, which can be any natural language such as English or Chinese.

It is worthwhile to note that there are various ways to convert the machine language into a natural statement mentioned here, for example, rule-based generation, which is to convert, by predetermining a mapping rule between different machine language elements and the natural language, the machine language into the natural language based on the mapping rule; template-based generation, which is to first create a predetermined language template, where the language template includes a format and a structure of natural language text, and then fill the template with related data or information to generate a complete natural language sentence or paragraph; and machine learning-based generation, which is to learn of a mapping relationship between the machine language and the natural language by using a supervised learning training model, or to explore, in an unsupervised learning way, a structure and a pattern of the natural language by using data that is not tagged, to generate corresponding natural language text, etc.

In addition, in this specification, user satisfaction is improved through interactive interpretation, to be specific, an interpretation way in which a dialog and interaction are performed between the user and the terminal device, for example, ways such as text display or a voice output are selected for presenting to the user.

It can be learned from the above-mentioned that, the recognition model that is pre-trained is used, to determine the interpretation strategies for the acquired question statement, and then the question statement is interpreted by using an applicable interpretation strategy, to improve accuracy of the reply statement, and then the user can formulate a solution or perform a next question-and-answer step based on the obtained reply statement in a more appropriate way

The above is a service execution method provided in embodiments of this specification, and based on the same idea, this specification further provides a corresponding apparatus, a storage medium, and an electronic device.

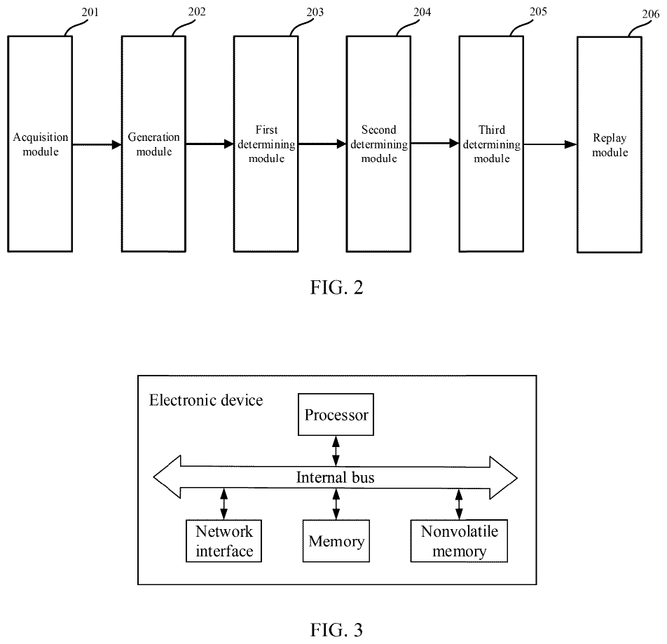

FIG. 2 is a diagram of a structure illustrating a service execution apparatus, according to one or more embodiments of this specification. The apparatus includes: an acquisition module 201, configured to acquire a question statement of a user, where the question statement is determined based on a service result output by a service model; a generation module 202, configured to generate a query statement based on the question statement, where the query statement is used to query user data of the user based on which the service model outputs the service result; a first determining module 203, configured to determine a query result based on the query statement; a second determining module 204, configured to input the question statement into a recognition model that is pre-trained, to determine an interpretation strategy used for the question statement; a third determining module 205, configured to determine, based on the query result through the interpretation strategy, an association relationship between at least part of the user data and the service result output by the service model; and a reply module 206, configured to generate a reply statement for the question statement based on the association relationship, to execute a target service through the reply statement.

Optionally, the generation module 202 is specifically configured to divide the question statement, to obtain component words based on the division; perform part of speech tagging on the component words, to obtain a tagging result; determine, as a target component word based on the tagging result, a component word whose part of speech is a noun from the component words, and determine a corresponding query parameter in the query statement based on the target component word; and determine the query statement based on the query parameter.

Optionally, the second determining module 204 is specifically configured to acquire each training sample, where the training sample is a simulation of the question statement determined by the user based on the service result output by the service model; input the training sample into a to-be-trained recognition model, so that the to-be-trained recognition model extracts a feature of the training sample, and determines, based on extracted feature information, an interpretation strategy corresponding to the training sample; and train the to-be-trained recognition model with an optimization target of minimizing a deviation between the interpretation strategy corresponding to the training sample and a tagged interpretation strategy corresponding to the training sample.

Optionally, the third determining module 205 is specifically configured to determine the at least part of the user data from the query result based on the interpretation strategy; adjust a user data value of the at least part of the user data, to obtain adjusted user data; input the adjusted user data into the service model, to obtain an adjusted service result; determine a deviation between the adjusted service result and the service result output by the service model based on the query result; and determine, based on the deviation, the association relationship between the at least part of the user data and the service result output by he service model.

This specification further provides a computer-readable storage medium. The storage medium stores a computer program, and when the computer program is executed by a processor, the service execution method provided in FIG. 1 can be performed.

Based on the service execution method provided in FIG. 1, one or more embodiments of this specification further provide a diagram of a structure of an electronic device shown in FIG. 3. As shown in FIG. 3, in terms of hardware, the electronic device includes a processor, an internal bus, a network interface, a memory, and a nonvolatile memory, and certainly can further include hardware needed by another service. The processor reads a corresponding computer program from the nonvolatile memory to the memory and then runs the computer program to implement the above-mentioned service execution method shown in FIG. 1.

Certainly, in addition to software implementations, this specification does not exclude other implementations such as a logic device or a combination of software and hardware. In other words, an execution body of the following processing procedure is not limited to each logical unit, and can be hardware or a logic device.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit to obtain a corresponding hardware circuit structure. Therefore, a method procedure can be improved using a hardware entity module. For example, a programmable logic device (PLD) (for example, a field programmable gate array (FPGA)) is such an integrated circuit, and a logical function of the programmable logic device is determined by a user through device programming. The designer independently performs programming to “integrate” a digital system to a PLD without requesting a chip manufacturer to design and manufacture an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the some described hardware description languages and is programmed into an integrated circuit.

A controller can be implemented by using any appropriate method. For example, the controller may be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using the computer-readable program code, logic programming can be performed on method steps to allow the controller to implement the same function in forms of the logic gate, the switch, the application-specific integrated circuit, the programmable logic controller, and the built-in microcontroller. Therefore, the controller can be considered as a hardware component, and an apparatus configured to implement various functions in the controller can also be considered as a structure in the hardware component. Alternatively, the apparatus configured to implement various functions can even be considered as both a software module implementing the method and a structure in the hardware component.

The system, apparatus, module, or unit illustrated in the above-mentioned embodiments can be implemented by using a computer chip or an entity, or can be implemented by using a product having a specific function. A typical implementation device is a computer. Specifically, for example, the computer may be a personal computer, a laptop computer, a cellular phone, a camera phone, a smart phone, a personal digital assistant, a media player, a navigation device, an e-mail device, a game console, a tablet computer, a wearable device, or any combination of these devices.

For ease of description, the above-mentioned apparatus is described by dividing functions into various units. Certainly, during implementation of this specification, functions of units can be implemented in the same or more software or hardware.

A person skilled in the art should understand that embodiments of this specification can be provided as methods, systems, or computer program products. Therefore, this specification can use a form of hardware only embodiments, software only embodiments, or embodiments with a combination of software and hardware. In addition, this specification can be in a form of a computer program product implemented on one or more computer-usable storage media (including but not limited to a magnetic disk storage, a CD-ROM, an optical storage, and the like) including computer-usable program code.

This specification is described with reference to the flowcharts and/or block diagrams of the method, the device (system), and the computer program product according to some embodiments of this specification. It should be understood that each process and/or each block in the flowcharts and/or the block diagrams and a combination of a process and/or a block in the flowcharts and/or block diagrams can be implemented by computer program instructions. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

These computer program instructions can be stored in a computer-readable memory that can instruct the computer or the another programmable data processing device to work in a specific way, so the instructions stored in the computer-readable memory generate an artifact that includes an instruction apparatus. The instruction apparatus implements a specific function in one or more processes in the flowcharts and/or in one or more blocks in the block diagrams.

These computer program instructions can alternatively be loaded onto the computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPU), an input/output interface, a network interface, and a memory.

The memory can include a form of a volatile memory, a random access memory (RAM) and/or a nonvolatile memory, and the like in a computer-readable medium, such as a read-only memory (ROM) or a flash memory (flash RAM). The memory is an example of the computer-readable medium.

The computer-readable medium includes a persistent and non-persistent, removable and non-removable medium, and can implement information storage by using any method or technology. Information can be a computer-readable instruction, a data structure, a program module, or other data. Examples of the storage medium of the computer include but are not limited to a phase-change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disk (DVD) or another optical storage, a magnetic cassette tape, a magnetic disk storage or another magnetic storage device, or any other non-transmission medium, which can be configured to store information accessible to a computing device. As specified in this specification, the computer-readable medium does not include transitory computer-readable media (transitory media), such as a modulated data signal and a carrier.

It should be further noted that, the terms “include”, “comprise”, or any other variant thereof are intended to cover a non-exclusive inclusion, so that a process, a method, a product or a device that includes a list of elements not only includes those elements but also includes other elements which are not expressly listed, or further includes elements inherent to such process, method, product or device. Without more constraints, an element preceded by “includes a . . . ” does not preclude the presence of additional identical elements in the process, method, product, or device that includes the element.

A person skilled in the art should understand that embodiments of this specification may be provided as a method, a system, or a computer program product. Therefore, this specification can be in a form of a hardware-only embodiment, a software-only embodiment, or an embodiment combining software and hardware aspects. In addition, this specification can be in a form of a computer program product implemented on one or more computer-usable storage media (including but not limited to a magnetic disk storage, a CD-ROM, an optical storage, and the like) including computer-usable program code.

This specification can be described in a general context of a computer-executable instruction executed by a computer, for example, a program module. Generally, the program module includes a routine, a program, an object, a component, a data structure, etc. executing a specific task or implementing a specific abstract data type. This specification can also be practiced in a distributed computing environment in which tasks are performed by remote processing devices connected via a communication network. In a distributed computing environment, the program module can be located in both local and remote computer storage media including storage devices.

The embodiments of this specification are described in a progressive way. For same or similar parts in the embodiments, reference may be made to each other. Each embodiment focuses on a difference from another embodiment. Particularly, some system embodiments are briefly described because they are basically similar to some method embodiments. For related parts, references can be made to related descriptions in some method embodiments.

The above-mentioned descriptions are merely embodiments of this specification, and are not intended to limit this specification. A person skilled in the art can make various modifications and variations to this specification. Any modification, equivalent replacement, or improvement made without departing from the spirit and principle of this application shall fall within the scope of the claims of this specification.

What is claimed is:

1. A computer-implemented method for service execution, comprising:
acquiring a question statement of a user, wherein the question statement is determined based on a service result output by a service model;
generating a query statement based on the question statement, wherein the query statement is used to query, based on, which the service model outputs the service result, user data of the user;
determining a query result based on the query statement;
inputting the question statement into a recognition model that is pre-trained, to determine an interpretation strategy used for the question statement;
determining, based on the query result through the interpretation strategy, an association relationship between at least part of the user data and the service result output by the service model; and
generating a reply statement for the question statement based on the association relationship, to execute a target service through the reply statement.

2. The computer-implemented method of claim 1, wherein generating a query statement based on the question statement comprises:
dividing the question statement, to obtain component words based on the division;
performing part of speech tagging on the component words, to obtain a tagging result;
determining, as a target component word based on the tagging result, a component word whose part of speech is a noun from the component words, and determining a corresponding query parameter in the query statement based on the target component word; and
determining the query statement based on the corresponding query parameter.

3. The computer-implemented method of claim 1, wherein pre-training the recognition model comprises:
acquiring each training sample, wherein the training sample is a simulation of the question statement determined by the user based on the service result output by the service model;
inputting the training sample into a to-be-trained recognition model, so that the to-be-trained recognition model extracts a feature of the training sample, and determines, based on extracted feature information, an interpretation strategy corresponding to the training sample; and
training the to-be-trained recognition model with an optimization target of minimizing a deviation between the interpretation strategy corresponding to the training sample and a tagged interpretation strategy corresponding to the training sample.

4. The computer-implemented method of claim 1, wherein determining, based on the query result through the interpretation strategy, an association relationship between at least part of the user data and the service result output by the service model comprises:
determining the at least part of the user data from the query result based on the interpretation strategy.

5. The computer-implemented method of claim 4, comprising:
adjusting a user data value of the at least part of the user data, to obtain adjusted user data.

6. The computer-implemented method of claim 5, comprising:
inputting the adjusted user data into the service model, to obtain an adjusted service result.

7. The computer-implemented method of claim 6, comprising:
determining a deviation between the adjusted service result and the service result output by the service model based on the query result; and
determining, based on the deviation, the association relationship between the at least part of the user data and the service result output by the service model.

8. A non-transitory, computer-readable medium storing one or more instructions executable by a computer system to perform one or more operations, comprising:
acquiring a question statement of a user, wherein the question statement is determined based on a service result output by a service model;
generating a query statement based on the question statement, wherein the query statement is used to query, based on, which the service model outputs the service result, user data of the user;
determining a query result based on the query statement;
inputting the question statement into a recognition model that is pre-trained, to determine an interpretation strategy used for the question statement;
determining, based on the query result through the interpretation strategy, an association relationship between at least part of the user data and the service result output by the service model; and
generating a reply statement for the question statement based on the association relationship, to execute a target service through the reply statement.

9. The non-transitory, computer-readable medium of claim 8, wherein generating a query statement based on the question statement comprises:
dividing the question statement, to obtain component words based on the division;
performing part of speech tagging on the component words, to obtain a tagging result;
determining, as a target component word based on the tagging result, a component word whose part of speech is a noun from the component words, and determining a corresponding query parameter in the query statement based on the target component word; and
determining the query statement based on the corresponding query parameter.

10. The non-transitory, computer-readable medium of claim 8, wherein pre-training the recognition model comprises:
acquiring each training sample, wherein the training sample is a simulation of the question statement determined by the user based on the service result output by the service model;
inputting the training sample into a to-be-trained recognition model, so that the to-be-trained recognition model extracts a feature of the training sample, and determines, based on extracted feature information, an interpretation strategy corresponding to the training sample; and
training the to-be-trained recognition model with an optimization target of minimizing a deviation between the interpretation strategy corresponding to the training sample and a tagged interpretation strategy corresponding to the training sample.

11. The non-transitory, computer-readable medium of claim 8, wherein determining, based on the query result through the interpretation strategy, an association relationship between at least part of the user data and the service result output by the service model comprises:
determining the at least part of the user data from the query result based on the interpretation strategy.

12. The non-transitory, computer-readable medium of claim 11, comprising:
adjusting a user data value of the at least part of the user data, to obtain adjusted user data.

13. The non-transitory, computer-readable medium of claim 12, comprising:
inputting the adjusted user data into the service model, to obtain an adjusted service result.

14. The non-transitory, computer-readable medium of claim 13, comprising:
determining a deviation between the adjusted service result and the service result output by the service model based on the query result; and
determining, based on the deviation, the association relationship between the at least part of the user data and the service result output by the service model.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
acquiring a question statement of a user, wherein the question statement is determined based on a service result output by a service model;
generating a query statement based on the question statement, wherein the query statement is used to query, based on, which the service model outputs the service result, user data of the user;
determining a query result based on the query statement;
inputting the question statement into a recognition model that is pre-trained, to determine an interpretation strategy used for the question statement;
determining, based on the query result through the interpretation strategy, an association relationship between at least part of the user data and the service result output by the service model; and
generating a reply statement for the question statement based on the association relationship, to execute a target service through the reply statement.

16. The computer-implemented system of claim 15, wherein generating a query statement based on the question statement comprises:
dividing the question statement, to obtain component words based on the division;
performing part of speech tagging on the component words, to obtain a tagging result;
determining, as a target component word based on the tagging result, a component word whose part of speech is a noun from the component words, and determining a corresponding query parameter in the query statement based on the target component word; and
determining the query statement based on the corresponding query parameter.

17. The computer-implemented system of claim 15, wherein pre-training the recognition model comprises:
acquiring each training sample, wherein the training sample is a simulation of the question statement determined by the user based on the service result output by the service model;
inputting the training sample into a to-be-trained recognition model, so that the to-be-trained recognition model extracts a feature of the training sample, and determines, based on extracted feature information, an interpretation strategy corresponding to the training sample; and
training the to-be-trained recognition model with an optimization target of minimizing a deviation between the interpretation strategy corresponding to the training sample and a tagged interpretation strategy corresponding to the training sample.

18. The computer-implemented system of claim 15, wherein determining, based on the query result through the interpretation strategy, an association relationship between at least part of the user data and the service result output by the service model comprises:
determining the at least part of the user data from the query result based on the interpretation strategy.

19. The computer-implemented system of claim 18, comprising:
adjusting a user data value of the at least part of the user data, to obtain adjusted user data.

20. The computer-implemented system of claim 19, comprising:
inputting the adjusted user data into the service model, to obtain an adjusted service result.
